(19) United States
(12) Patent Application Publication
(10) Pub. No.: US 2012/0323753 A1
(43) Pub. Date: Dec. 20, 2012

(54) CLEARING SYSTEM

(76) Inventors: Monica Norman, Spanga (SE); Lars-Göran Larsson, Vallentuna (SE); Hannes Edvardson, Uppsala (SE)

(21) Appl. No.: 13/160,047

(22) Filed: Jun. 14, 2011

(51) Int. Cl. G06Q 40/04

(52) U.S. Cl. 705/37

(57) ABSTRACT

A clearing system for clearing transactions associated with a plurality of accounts, the clearing system being configured to organise the plurality of accounts in at least three independent structures comprising a member structure, a user access structure and a risk calculation structure. The clearing system may further be configured to organise a plurality of members clearing through the clearing system and a plurality of users using the clearing system in a tree structure independent from said three independent structures.

### FIELD OF THE INVENTION

The invention relates to the grouping of data elements in a computer system. More specifically, but not exclusively, it relates to the grouping of accounts in a clearing system.

### BACKGROUND OF THE INVENTION

Data objects are often arranged in tree structures in computer systems. Tree structures allow a relationship to be defined between a parent node and a number of child nodes. A child node can only have one parent. Tree structures are often used to define the relationship between members and accounts in financial systems.

An example of a financial system that traditionally uses tree structures to store member details and account details is a clearing system. A clearing system handles all activities from the time a commitment is made for a transaction in a trading system until the trade is settled. A clearing system has two types of members, clearing members and non-clearing members. Non-clearing members trade in their own names but clear through a clearing member. This means that from the perspective of the clearing house, it is the clearing member that is responsible for the non-clearing member's trade. A member and account structure is normally implemented in the clearing system by building a tree of member objects and account objects, where non-clearing members are child objects to clearing members and account objects are child objects to members. There are problems with such a structure since a non-clearing member may want to clear trades through more than one clearing member and a child object can only have one parent object in the structure.

A solution to these problems involves the clearing system storing a dedicated trading account for each non-clearing member. Both clearing members and non-clearing member objects have accounts below them, and there is no parent-child relationship between the clearing member objects and the non-clearing member objects. However, the dedicated trading account belonging to the non-clearing member refers to a clearing account belonging to a clearing member and trades reported to the non-clearing member's accounts are duplicated and inserted on the clearing member's account. The clearing member typically only has one account for non-clearing members, which means that several non-clearing member accounts refer to the same clearing member account. The disadvantage of this design is the increased complexity of duplicating trades and the risk of getting inconsistencies between the contents shown in the non-clearing member view and the contents on the clearing member account used for non-clearing members' trades.

Another problem with the above mentioned approaches is that a clearing system may require a more flexible account structure to carry out risk assessments. In more detail, a clearing house is legally required to demand sufficient collateral from its members to cover the potential loss of a member not being able to settle its trade. The clearing house therefore needs to calculate the worst realistic value drops of its members' positions and demand that collateral be made available to cover the potential loss. The laws of the country that the clearing house resides in determine on which levels risk calculations must be made. Typically, the positions in some accounts may be balanced, or “netted” with the positions in other accounts. It is in the interest of the clearing members that the account groups for which risk is calculated are made as large as possible, since this makes it possible to net a buy trade in one account against a sell trade in another account in the same group and reduce the risk. However, in a tree structure as described above, the netting groups are limited by the structure of the accounts.

Moreover, members may want to know the risks for other netting groups or the risks calculated using alternative algorithms to those required by the regulators. Members may also want to know the risks associated with smaller groups of accounts. These risks are typically calculated on historical data after the risks required by the regulators are calculated and the implementation to calculate risks for new groups is often complex. The new groups are often implemented by including exceptions in the code used to carry out the instructions. As soon as a new type of group or algorithm is required, a new exception has to be included in the code.

Additionally, it is desired to allow users access to particular accounts and stop them from accessing other accounts. However, the access to the accounts is again limited by the tree structure and access to any groups not defined by the tree structure is implemented in known systems using exceptions.

The invention was made in this context.

### SUMMARY OF THE INVENTION

A clearing system for clearing transactions associated with a plurality of accounts, the clearing system being configured to organise the plurality of accounts in at least three independent structures comprising a member structure, a user access structure and a risk calculation structure.

The three independent structures may only comprise accounts and groups of accounts. The clearing system may further be configured to organise a plurality of members of the clearing system and a plurality of users using the clearing system in a tree structure independent from said three independent structures. Accordingly, the accounts are not organised as child objects to members of the clearing system. The users may be associated with different members or with the clearing system.

The clearing system may comprise a controller arrangement and a memory configured to organise information about the plurality of accounts, the plurality of members and the plurality of users. The controller arrangement may be configured to receive information related to an account of the plurality of accounts and organise the received information with respect to the three independent structures in the memory. The memory may comprise an account database for organising the information about the accounts in the three independent structures and a member database arrangement for organising the information about the plurality of members and the plurality of users independently from said three independent structures.

The members may comprise clearing members and non-clearing members. The member structure may comprise a plurality of member groups and clearing system may be configured to organise accounts into member groups in dependence on the clearing member responsible for the account. The user access structure may comprise a plurality of user access groups and clearing system may be configured to organise the plurality of accounts into user access groups based on the one or more users allowed to access information about the accounts. The risk calculation structure may comprise a plurality of risk groups and the clearing system may comprise one or more risk calculation servers configured to calculate a risk for each risk group of the plurality of risk groups, the one or more risk calculation servers being configured to net the positions of the accounts in each risk group of the plurality of risk groups.

The invention therefore provides a flexible account structure. An account can be moved from one group to another in one of the structures without the other structures being affected.

Moreover, the structure allows a non-clearing member to have a number of accounts belonging to different clearing members as defined by the member structure. The non-clearing member can access all of its accounts since the accounts can be organised into access groups, defined by the user access structure, to which the non-clearing member has access.

The risk calculation structure may comprise a first risk calculation structure comprising a first set of risk groups and the clearing system may further be configured to organise the accounts into a second risk calculation structure comprising a second set of risk groups. The first set of risk groups may be determined based on risk groups required by regulators and the second set of risk groups may be determined based on information desired by users of the clearing system. Consequently, the clearing system can use the second risk calculation structure to form different risk netting groups than the ones allowed by the regulators.

A risk group in the first set of risk groups and a risk group in the second set of risk groups may comprise the same accounts and the one or more risk calculation servers may be configured to carry out a stress-test for said accounts using the risk group of the second set of risk groups.

The clearing system may further comprise a plurality of risk calculation servers configured to carry out risk calculations for the plurality of risk groups in parallel.

The clearing system may further comprise a database for storing for every account data indicating a member group to which the account belongs, data indicating a user access group to which the account belongs and data indicating at least one risk calculation group to which the account belongs.

The clearing system may further comprise a volatile memory for loading the content of said database at start-up of the system.

According to the invention, there is also provided a method for managing accounts in a clearing system, the method comprising: organising accounts in at least three independent structures comprising a member account structure, a user access structure and a risk calculation structure.

The three independent structures may only comprise accounts and groups of accounts. The method may further comprise organising a plurality of member units of members clearing through the clearing system in a tree structure independent from said three independent structures.

The member account structure may comprise a plurality of member groups, the user access structure may comprise a plurality of user access groups and the risk calculation structure may comprise a plurality of risk groups.

The method may further comprise organising said accounts in a first and a second risk calculation structure, the first risk calculation structure comprising a first set of risk groups determined based on requirements of regulators and the second risk calculation structure comprising a second set of risk groups determined based on information desired by users of the clearing system. The method may further comprise carrying out a risk assessment for a risk group, wherein carrying out a risk assessment for a risk group comprises netting the positions of the accounts in a risk group. The method may further comprise carrying out risk assessments on said risk groups in parallel.

The method may further comprise organising a group of a accounts into a first risk group belonging to the first set of risk groups and a second set of risk groups belonging to the second set of risk groups, the first and second groups comprising the same accounts, and running a first risk assessment for the first risk group and a second risk assessment for the second risk group.

The method may further comprise storing a record for each account in a database, the record comprising an indication of the member to which the account belongs, an indication of a user access group to which the account belongs and an indication of at least one risk group to which the account belongs; and loading the content of said database into memory on start-up of the clearing system.

According to the invention, there is also provided a computer program comprising instructions that when executed by a processor cause the processor to carry out the above method.

Furthermore, according to the invention, there is provided a data structure for organising accounts in a clearing system, the data structure comprises a field comprising an indication of the member to which an account belongs, a field comprising an indication of a user access group to which the account, a field comprising an indication of a first risk group to which the account belongs; and a field comprising an indication of at least a second risk group to which the account belongs.

The first risk group may be determined based on requirements of regulators of the clearing system and the second risk group may be determined with consideration to information desired by members of the clearing system.

According to the invention, there is also provided a clearing system for clearing transactions associated with a plurality of accounts, the clearing system comprising: means for organising the plurality of accounts in at least three independent structures comprising a member structure, a user access structure and a risk calculation structure.

The clearing system may also comprise means for organising information corresponding to a plurality of members clearing through the clearing system and a plurality of users using the clearing system in a tree structure independent from said three independent structures.

### BRIEF DESCRIPTION OF THE DRAWINGS

Embodiments of the invention will now be described, by way of example, with reference to FIGS. 1 to 14 of the accompanying drawings, in which:

FIG. 1 is a schematic block diagram showing components of a clearing system in communication with a trading system;

FIG. 2 is a schematic block diagram showing components of the account manager of the clearing system;

FIG. 3 is a schematic block diagram showing components of the risk manager of the clearing system;

FIG. 4 is a schematic diagram showing components of the publication manager of the clearing system;

FIG. 5 is a diagram illustrating the relationship between different types of members of the electronic trading system;

FIGS. 6 and 7 are diagrams illustrating different types of users of the clearing system;

FIG. 8 illustrates how accounts can be grouped in the clearing system according to embodiments of the invention;

FIG. 9 illustrates a data structure for a record corresponding to an account managed by the clearing system;

FIG. 10 illustrates a data structure for a record corresponding to a user of the clearing system;

FIG. 11 illustrates a data structure for a record corresponding to a member of the clearing system;

FIG. 12 illustrates a process for handling information about events affecting accounts managed by the clearing system;

FIG. 13 illustrates a process for carrying out risk calculations in the clearing system; and

FIG. 14 illustrates a process for publishing information to users in the clearing system.

### DETAILED DESCRIPTION

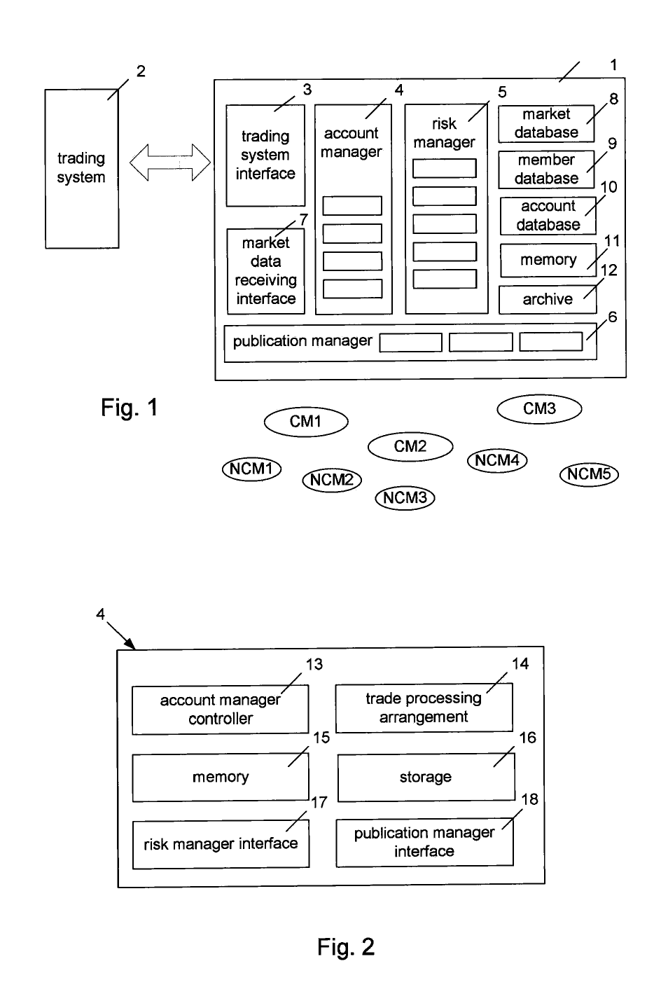

With reference to FIG. 1, a clearing system 1 is shown in communication with a trading system 2. The clearing system 1 handles all activities from the time a commitment is made for a transaction in the trading system 2 until the trade is settled. The clearing system 1 receives details of created trades from the trading system 2. Once a trade has been settled, the clearing system 1 reports back to the trading system 2. It may also inform the trading system 2 if a member has not provided sufficient collateral as security to match the risk associated with the member's accounts. In additional to receiving and handling details of trades at the trading system, the clearing system may also receive and handle trades from banks and other institutions.

The clearing system 1 comprises a trading system interface 3, an account manager 4, a risk manager 5 and a publication manager 6. The trading system interface 3 receives details of trades from the trading system 2. The trading system interface 3 also returns information about settled trades. Additionally, the trading system interface 3 returns information about the risks associated with the accounts held by the clearing system to the trading system 2. The account manager 4, the risk manager 5 and the publication manager 6 may each comprise a plurality of servers and the servers are configured to carry out a number of tasks for managing the accounts, calculating the risks associated with certain accounts to ensure that the members have provided enough collateral to the clearing system as security and publishing information to users of the system. The tasks carried out by the account manager 4, the risk manager 5 and the publication manager 6 will be described in more detail below.

It is contemplated that each risk manager server and each publication server is configured as a slave to one or more account manager services. Different account manager servers handle different accounts and the risk manager servers and the publication servers handle the risk assessments and the publication of information respectively for the accounts of the account manager server for which they act as slaves. In some embodiments, servers are partitioned per member. For example, accounts belonging to a number of members may be allocated to the same specific account manager server and the risk assessments for the different members may be carried out by different risk manager servers of the risk manager servers that act as slaves to the account manager server. One or more risk manager servers may be used for each member. Some servers may also carry out risk calculations for a number of different members.

The trading system interface 3 comprises messaging software configured to send incoming information about new trades to the right account manager server. The account manager servers then notify the new trades to the risk manager servers. Additionally, the account manager servers forward information to be published to the publication servers. The trading system interface 3 also comprises messaging software for forwarding information from the account manager 4 to the trading system 2.

The clearing system further comprises a market data receiving interface 7 for receiving up-to-date market data. The market data may be received from the trading system 2 or from third parties. When new market data has been received, the market data receiving interface informs the account manager 4.

The clearing system further comprises a number of databases. It comprises a market database 8 for storing the up-to-date market data received from the market data receiving interface 7. It also comprises a member database 9 for storing details of the members clearing through the clearing system and the users that need to access data stored by the clearing system. The users may either be clearing house officials or attached to a particular clearing or non-clearing member. The clearing system further comprises an account database 10 for storing details of the accounts used by the members, details of instruments held by the accounts and details of the risk algorithms used to carry out risk assessments for the accounts.

The clearing system also comprises a memory 11 for storing additional data and software required. For example, the memory may store additional data and programme code for analysing different types of instruments and for carrying our risk assessments. The clearing system also comprises an archive 12. The archive 12 stores data for allowing historical changes to the accounts and risk assessments to be monitored and reports to be generated. The clearing house may also comprise an interface (not shown) for allowing users to request changes to their accounts and to inform the clearing system of any changes to the member details.

With reference to FIG. 2, each server of the account manager 4 comprises an account manager controller 13, a trade processing module 14, a volatile memory 15 and storage 16. The volatile memory 15 may be a random access memory (RAM). It may store data that needs to be accessed quickly. The storage 16 may be a non-volatile memory and may be provided by hard disk drives. At start up, the account manager may load the contents of the account database 10 and also the contents of the accounts stored in the hard disk drives 16 to the volatile memory 15 to be directly accessible by the account manager controller 13. At the end of the day, when all trades have been cleared, the account database 10 may be updated based on the data stored in the volatile memory 15 and the contents of the accounts may be written to one or more files in the hard disk drive 16 of the server. Each account manager server therefore stores a copy of the contents of the accounts. It should be realised that the system does not have to be restarted every day. It can be restarted more or less often. For example, it is contemplated that it can be restarted once every week. The account manager may also write data to the storage 16 in order to, for example, recover quickly in case of a hardware fault or facilitate fault-finding in some circumstances. Each server of the account manager 4 also comprises a risk manager interface 17 for interfacing with the risk manager 5 and a publication manager interface 18 for interfacing with the publication manager 6.

With reference to FIG. 4, every risk server of the risk manager 5 comprises a risk manager controller 19 for controlling the risk manager server and a risk calculator 20 for carrying out the risk assessments. The risk manager controller 19 decides whether a risk assessment needs to be carried out for an account or a group of accounts and allocates the task to an instance of the risk calculator 20. The risk calculator 20 may be running a plurality of risk calculations at the same time. The risk manager controller 19 may delegate a new risk assessment to a portion of a server available to carry out the risk assessment.

Every server of the risk manager 5 also comprises a volatile memory 21 and storage 22 for storing data that is required for the risk manager to perform the risk calculations. The volatile memory 21 may be a RAM memory. The storage 22 may be non-volatile memory provided by the hard disk drives of the risk servers. When the system is activated, the content of the account database 10 is downloaded into the volatile memory 21 of the risk manager. The contents of the accounts are also downloaded from the account manager into the volatile memory 21 to allow the contents of the account to be easily accessed by the risk manager controller 19 and risk calculator 20. If any changes to the account structure occurs during the day, both the volatile memory 15 of the account manager 4 and the volatile memory 21 of the risk manager 5 are updated. Moreover, if a new trade is received, the account manager informs the risk manager 5 and the risk manager stores details of the new trade in memory 21. The risk manager may write data to the storage 22 in order to, for example, recover quickly in case of a hardware fault or to facilitate fault-finding.

The risk manager servers 5 also comprise an account manager interface 23 for interfacing with the account manager. As mentioned above, each risk manager may act as a slave to one or more account manager servers and may receive instructions from, and report back to, the one or more account manager servers. It is contemplated that, in some implementations, each risk server may store information of all new trades but will only access the information necessary to carry out the required risk assessments allocated to that server.

With reference to FIG. 4, each server of the publication manager 6 comprises a publication manager controller 24 for processing data to be published. The publication also comprises a volatile memory 25 and storage 26. The volatile memory may be a RAM memory and the storage may be a non-volatile memory provided by the hard disk drives of the publication servers. Records from the member database 9 and the account database 10 may be loaded into the memory 25 on start-up to allow the publication manager to determine access rights to the information to be published. The storage 26 may store code and data for processing and publishing the information received by the publication manager. Some or all of the code and data may also be loaded into the volatile memory 25 at start-up to be easily accessible by the publication manager controller 24. The publication manager may also write data to the storage 26 from the volatile memory in order to, for example, recover quickly in case of a hardware fault. The publication manager also comprises an account manager interface 27 for receiving the information to be published from the account manager 4.

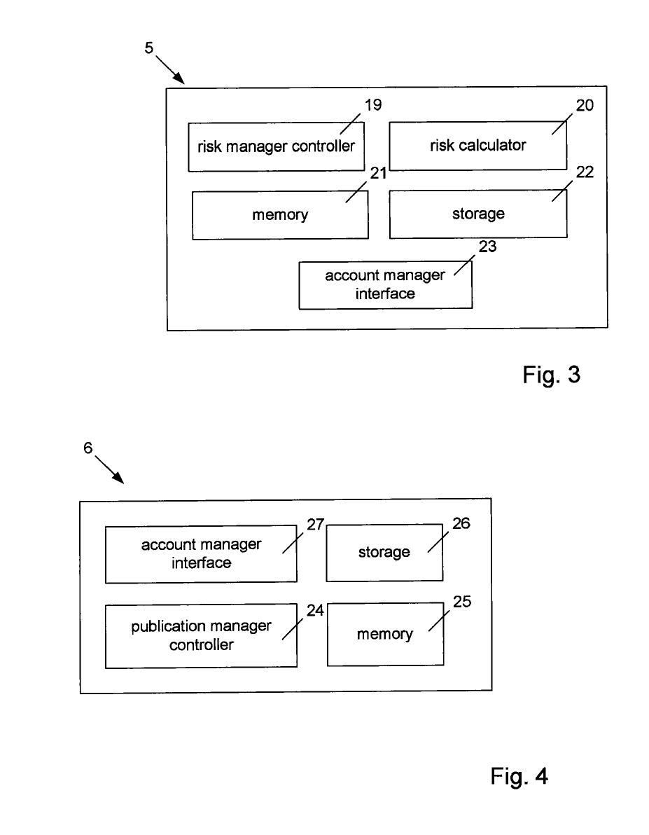

The components of the account manager, risk manager and publication manager described with respect to FIGS. 2, 3 and 4 may be implemented using hardware, software or a combination of both. It is contemplated that the controllers 13, 19, 24 are provided by processor arrangements having internal memory for storing programme code and required data.

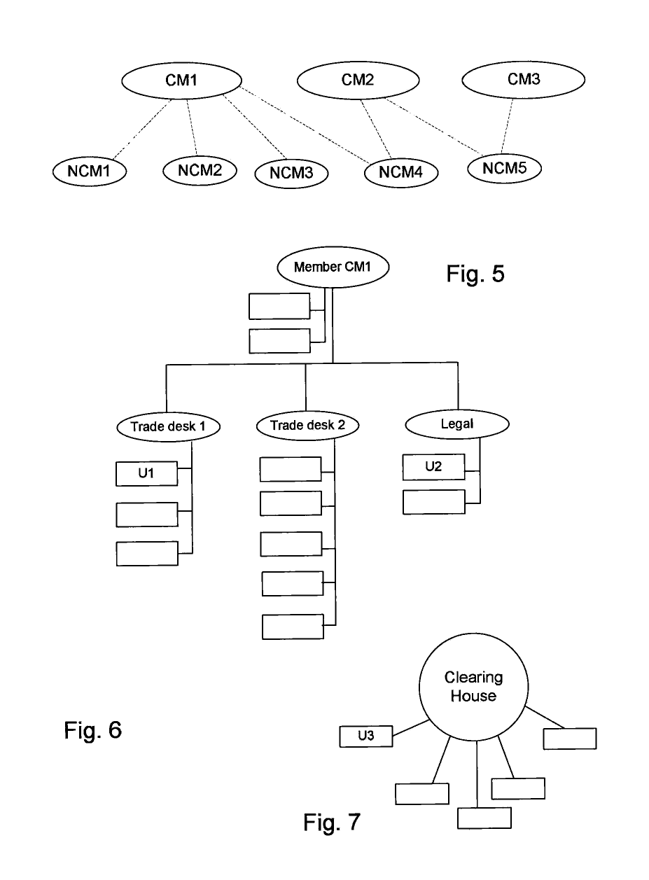

It will now be described with reference to FIGS. 5 to 8 how the members, the users and the accounts are organised according to some embodiments of the invention. The system can receive information about new and existing accounts and new and existing members and users and organise the information in the structures described below. The information may be received from a clearing house official or a user. With reference to FIG. 5, both clearing members, CM1, CM2 and CM3, and non-clearing members, NCM1, NCM2 and NCM3, NCM4 and NCM5, can be involved in trades. Non-clearing members trade in their own name, but clear through a clearing member. From the perspective of the clearing house, it is the clearing member that is responsible for the non-clearing members' trades. One non-clearing member, NCM4, NCM5, may trade through several clearing members, CM2, CM3, as indicated by the dashed lines in FIG. 5.

The clearing system stores a separate member and user structure for each clearing member. The structures of different members are not linked in a tree structure. Accordingly, in contrast to some prior art systems, non-clearing members are not organised as child objects to clearing members. A non-clearing member may still have access to the clearing member's account that the non-clearing member uses to trade, as will be described below.

Each member may have a plurality of member objects corresponding to member units organised in a member and user tree structure, as shown in FIG. 6. Different member object hierarchies can be used for different members. For example, for one trading house, a member object CM1 organised as the highest member object may be created for the directors of the trading house. The child member objects may correspond to different departments of the trading house. The different departments may comprise the legal department, a first trade desk and a second trade desk, as shown in FIG. 6. The child member objects may have their own child member objects.

Each member unit may have a plurality of registered users as further shown in FIG. 6 and different users may be included as child objects to different member objects in the member and user structure. The users may be organised according to the different roles of the users within the firm. Consequently, in the example of FIG. 6, a number of users corresponding to directors are organised as direct child objects of the director member object CM1. Moreover, the traders U1 at the first trade desk and the traders at the second trade desk are organised as child objects of the member objects corresponding to the first and the second trade desk respectively. Additionally, the users U2 working in the legal department are organised as child objects to the member object corresponding to the legal department. As shown in FIG. 7, the system also allows for users U3 working for the clearing house.

The member and user structures are stored in the member database 9. The member database may store one record for each member object. In some embodiments, the clearing house may also be represented as a number of member objects in the database. The member database may also store one record for each user. The records of the users in the member database will be described with more detail with respect to FIG. 10.

It should be realised that although the member structure in FIG. 6 has been shown for a clearing member CM1, corresponding member structures are also stored for the non-clearing members, NCM1 to NCM5. Separate member objects corresponding to different departments of non-clearing member may also be stored.

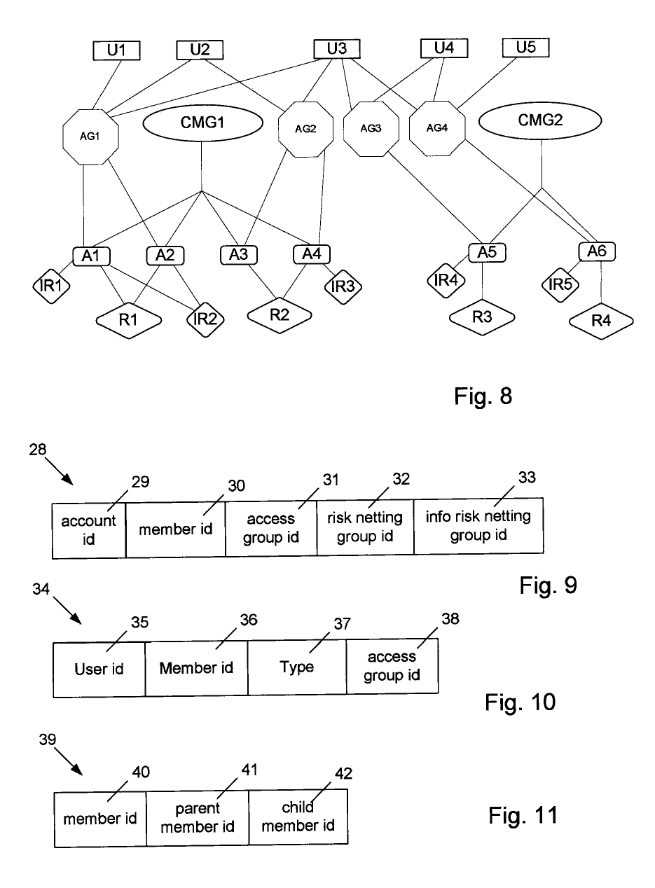

The grouping of the accounts, according to some embodiments of the invention will now be described with respect to FIG. 8. With reference to FIG. 8, a structure of accounts is formed for each clearing member CM1, CM2. The structures only comprise accounts and group of accounts. As described above, the members are placed in a separate data structure, outside the account structure. Consequently, the accounts are not child objects to member objects. Member CM1 has four accounts, A1, A2, A3 and A4, at the clearing house. Member CM2 has two accounts A5, A6. It is contemplated that two of the accounts, A1, A2, belonging to member CM1 hold the member's own positions and are known as house accounts. One of them may be for transactions carried out by traders belonging to the first trade desk and one of them may be for transactions carried out by traders belonging to the second trade desk. The other two accounts, A3, A4, hold the positions of non-clearing members, NCM1, NCM2, NCM3 and NCM4, clearing through member CM1 and are known as client accounts. Similarly, the first account A5 of member CM2 may be a house account and the second account A6 may be a client account. The accounts A1 to A6 are grouped into clearing member groups according to which clearing member is responsible for the accounts. The accounts A1 to A4 for which the first clearing member CM1 is responsible are grouped into a first clearing member group CMG1 corresponding to the first clearing member CM1. The accounts A5 and A6 of the second clearing member CM2 are grouped into a second clearing member group CMG2 corresponding to the second clearing member CM2. Consequently, the accounts are grouped according to a first structure corresponding to a clearing member account structure.

The accounts are also organised according to a second structure, an access group structure. By access, it is meant the right to monitor and/or take actions for an account. Different users have access to different accounts depending on who they work for and what they do. An employee of the clearing house may have access to a larger number of accounts than an employee in the legal department of a particular member. Moreover, the employee in the legal department of a trading house may have access to a larger number of accounts than a trader for the trading house.

The first two accounts A1, A2 of member CM1 belong to a first access group AG1. The second two accounts A3, A4, of member CM1 belong to a second access group AG2. Access group AG3 comprises the first account A5 of member CM2 and access group AG4 comprises the second account A6 of member CM2. User U1 may be a trader for member CM1 and is therefore allowed access to the trading accounts, A1 and A2, of member CM1. User U1 is not allowed access to accounts A3 and A4 since these are used for trades of non-clearing members and effectively show a competitor's books. User U1 therefore only has access to access group AG1. In some situation, if a member has different trading desks, a trader may only have access to the accounts of the trading desk to which the trader belongs. User U2 may be a risk assessor at the legal department of member CM1 and must therefore have access to all accounts of member CM1, both house accounts and client accounts. User U2 therefore has access to both access group AG1 and access group AG2. User U3 may be working at the clearing house and is responsible for all trades of member CM1 and CM2 and therefore have access to all accounts thorough user groups AG1, AG2, AG3 and AG4. User U4 may be a risk assessor working for member CM2 and therefore has access to all accounts belonging to member CM2 through access groups AG3 and AG4. U5 may be a non-clearing member clearing through the second account A6 of member CM2. User U5 therefore only has access to access group AG4.

In some embodiments, the rights to access information is inherited vertically in the member and user tree structures shown in FIGS. 6 and 7 and user belonging to a particular member object has access to all the accounts to which the users of the child objects of the particular member object have access. Consequently, a user directly under the director member object would have access to all access groups to which the users of the first trade desk, the second trade desk and the legal department have access. In some embodiments, an account can belong to only one access group.

The accounts are also arranged according to a risk calculation structure. The accounts are grouped into four different risk netting groups R1, R2, R3 and R4 used to carry out risk assessments demanded by regulators. In other words, the accounts may be organised into specific risk netting groups determined in accordance with legal requirements. When carrying out risk calculations, all positions of the accounts in the same risk netting group are netted. In other words, the risk assessment can be calculated based on the net positions of the accounts. Group R1 allows the positions in accounts A1 and A2 to be netted. Group R2 allows the positions in accounts A3 and A4 to be netted. R3 and R4 allow risk assessments to be made on account A5 and A6 respectively. A risk assessment can also be calculated based on the net positions of all accounts in a number of risk netting groups.

The accounts are also grouped into a number of different information risk netting groups IR1, IR2 and IR3. The information risk netting groups are used to carry out risk calculations that are not required by the regulators but which may be useful to the members of the clearing system or the clearing house itself. For example, while regulators may allow all accounts of a member to be netted for risk assessments, the clearing house may be interested in the risk associated with smaller groups of accounts. For example, the clearing house may be interested in determining the risk associated with smaller groups of a member's accounts to allow it to offer, as a service to its members, risk assessments for separate departments and/or specific non-clearing members clearing through the member. The clearing house should not be affected if a non-clearing member defaults. This is because as far as the clearing house is concerned the account is the responsibility of the clearing member through which the non-clearing member clears and the clearing member CM1 has provided sufficient collateral to cover the potential loss of a trade in one of the clearing member's accounts not being settled. However, the clearing member may suffer financial losses if the non-clearing member defaults. The member may use the service offered by the clearing house to determine how much collateral the different departments or non-clearing members should provide as security. The clearing house may also use information risk netting groups to try alternative risk algorithms, not required by the regulators, for evaluating the risks associated with the positions held by the accounts. In some embodiments, an account can only belong to one risk netting group but many information risk netting groups.

In the example shown in FIG. 8, account A1 belongs to two different information risk netting groups IR1, IR2. IR1 only comprises account A1. It is contemplated that trades for a specific instrument type may be registered in account A1 and member CM1 is therefore interested in finding the risk associated with this account separately even though regulators allow accounts A1 and A2 to be netted. In some embodiments, an information risk group is established for each instrument type to allow the risk for each instrument type to be monitored. Alternatively, trades for a particular trader may be registered on account A1 and the member may be interested in finding out the individual risk activity of that trader by using risk group IR1. In some embodiments, it is contemplated that each trader has a separate account or a number of separate accounts and an information risk group is established for each trader's accounts to allow the risks associated with each trader's activities to be monitored.

IR2 comprises both account A1 and account A2. These two accounts already form a risk netting group R1. However, it is possible that the clearing house or the member is interested in carrying out a different risk assessment, not required by the regulator, for risk netting group R1. Carrying out the different risk assessment may involve running an alternative algorithm or repeating the same algorithm but with modified parameters. It may be desired to repeat the same algorithm with different parameters to “stress-test” the algorithm. A separate information risk netting group IR2 has therefore been created for these accounts. Previously, to stress-test an algorithm, the risk calculations would have to be carried out on historical data for the accounts at a later time. By using a separate information risk netting group, IR2, containing the same accounts, the algorithm can be stress-tested for the accounts of risk netting group R1 in real-time. The risk calculations for the information risk netting group IR2 can be run in parallel with the risk calculation required by the regulators for risk netting group R1.

Account A4 belongs to information risk netting group IR3. It is contemplated that the trades of a specific non-clearing member NCM1 are registered in account A4 and the member CM1 may want to know the risk associated with this account to ask the non-clearing member to provide sufficient collateral as security even though regulators allow this account to be netted with account A3 in risk group R2. The clearing house may run a separate risk calculation for account A4 in risk group IR3 and continuously notify CM1 about the current risk as a service to member CM1.

Moreover, information risk netting group IR4 only comprises account A5 and information risk netting group IR5 only comprises account A6. These information risk netting groups allow alternative algorithms to be used to carry out the risk assessments for the second member's accounts.

With reference to FIG. 9, to allow the accounts to be grouped into member groups, access groups, risk netting groups and information risk netting groups, each account may be stored in the account database 10 as a data structure 28 with a number of fields. The values of some of the fields define the groups to which the account belongs. The record for the account includes a field 29 for the account identification number. It also includes a field 30 for the identification number of the member that is responsible for the account. In one embodiment, this would always be a clearing member. Additionally, it includes a field 31 for the identification number of the access group to which the account belongs. The data structure also includes a field for the identification number for the risk netting group 32 to which the account belongs. Additionally, it includes one or more fields for the identification number of the one or more information risk netting groups 33 to which the account belongs. In some embodiment, there may be only a single field storing more than one risk netting group identification numbers. In other embodiments, there may be a number of fields or sub-fields storing the identification numbers. If the account does not belong to an information risk netting group, the field or fields may be empty. It is contemplated that the information risk netting group ID field may be divided up into a fixed number of sub-fields. The number of subfields may correspond to the maximum number of information risk netting groups to which an account may belong. Most of the accounts will belong to fewer information risk netting groups than the maximum number of information risk netting groups and some or most of the fields will then be empty. Consequently, the records stored in the account database allow the accounts to be organising into a number of independent structures. The records stored in the account database 10 may be loaded into volatile memory in the account manager, the risk manager and the publication manager on start-up.

Using the example of account A1 of FIG. 8, the entry in the account database would have a member ID equal to CM1, an access group id equal AG1, a risk netting group ID equal to R1 and information risk netting group IDs equal to IR1 and IR2.

The account manager 4 may also store records (not shown) linking the account id with the address in the memory where the positions of the account are stored. The positions may be stored in a large data structure and organised according to the different instruments and other characteristics of the trades registered in the account. The data structure is held in volatile memory 15 of the account manager when the system is active and stored on file when the system is inactive. When the system is not active, the address in the account manager records, indicating the location where the contents of the accounts are stored, may be a pointer to the address in storage 16 of the account manager servers. At start-up, when the account data structures storing the positions of the account are loaded into volatile memory 15, new records may be created in the volatile memory linking the account id to the new address in volatile memory 15. Corresponding records but with pointers to the address space in volatile memory 21 of the risk servers may be created in the risk servers when the account data is loaded into memory in the risk manager servers.

With reference to FIG. 10, to implement the member and user structure, a user record 34 with a number of fields may be stored in the member database. The structure for the user record 34 may include a field 35 for the ID of the user. The structure may also include a field 36 for indicating to which member the user belongs. If the user is associated with a member, this field 36 includes the identification number for the member unit to which the member belongs. If the user is associated with a particular trading desk, the field includes the identification number of the member object corresponding to the trading desk. If instead the user is a director, the field includes the identification number of the member object corresponding to the director member unit. If the user is associated with the clearing house, the field may indicate that the user belongs to the clearing house instead. Additionally, but not necessarily, the structure may also include a field 37 indicating the type of the user, such as whether the user is a trader or an employee in the legal department. Moreover, the user structure includes a field 38 listing the IDs of the access group to which the user has access. Considering user U1 as an example, the member field could include value CM1, the type field could indicate that the user is a trader and the access group field could include the identification number for access group AG1. However, for user U3, the member would be the clearing house, the type field may indicate that the user is a clearing official and the access group field would include four access groups, AG1, AG2, AG3 and AG4.

With reference to FIG. 11, to implement the member and user structure, a member record 39 may also be stored in the member database. The record 39 for a member object includes a field 40 for the identification number of the member. Moreover, since member objects corresponding to the member units may be organised in a tree structure, the record also includes a field 41 for the identification number of the parent member and a field 42 including one or more sub-fields for the identification numbers of the child members. In some embodiments, the record may not include the child member id field 42 since whether an object is a child member object of the member object can be deduced from the parent member id field of the other object.

Using the example of FIG. 5 as an example, if the member object is director member object CM1, the parent member field may be empty but the child member fields may include the identification numbers for the member objects corresponding to the first trading desk, the second trading desk and the legal department. If instead, the member object is the member object of the first trade desk, the parent member id field may include the identification number of the director object corresponding to the first member CM1 and the child member id field may be empty.

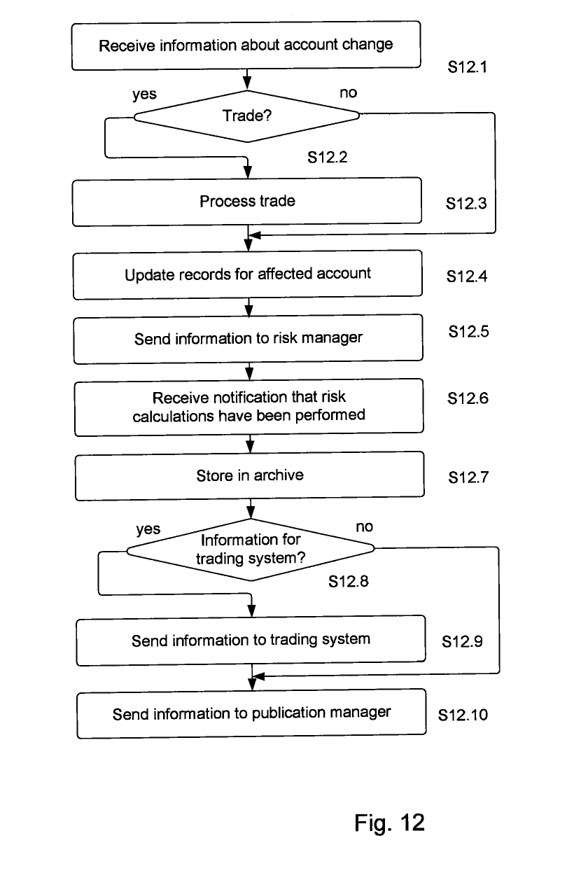

The processes of updating the accounts, calculating risks and publishing changes to the accounts will now be described with reference to FIGS. 12 to 15.

With reference to FIG. 12, an event affecting the account is received by the account manager controller 9 at step S12.1. The event may be a trade, a change that affects the grouping of the account or a change to market data that affects the account. In some systems, new market data may be received at regular intervals or in response to important events. A trade can be registered by a clearing official based on trades coming from the trading system or by a user registering a trade between two internal accounts. An event related to the re-grouping of the account can also be entered by a clearing official or by a user. The event may be the creation of a new access group, a new risk netting group, a new information risk netting group or the transfer of the account to an existing member group, access group, risk netting group or information risk netting group. In some embodiments, different account manager servers handle different accounts. If the change relates to an account for which a particular account manager server is responsible, the server will start to process the change.

It is checked at step S12.2 whether the event is a trade and if the event is a new trade, the account manager controller 13 of the server instruct the trade processing arrangement 14 of the server to process the trade. The trade processing arrangement 14 processes the trade at step S12.3. Processing of the trade is known in the art and will not be described in detail herein. Processing of the trade can comprise trade confirmation/affirmation, trade validation and debiting and crediting of accounts. When the trade has been processed, the process moves on to step S12.4 and the accounts affected by the trade are updated. If it is found at step 12.2 that the received event is not a trade, the process proceeds to update the affected accounts without performing any trade processing. If the event is a trade, the positions held on the accounts affected by the trade are updated in step S12.4. If the event is a change to the grouping of an account, the values of the relevant fields of the record for the account are updated at step S12.4. If the received information relates to updated market data, the value of the positions for the account is recalculated. Since the records for the accounts have been loaded into volatile memory 15 from the account database, the changes can be made in the records stored in volatile memory 15. The updates to the accounts can therefore be completed in a shorter time. The updates to the account in the volatile memory 15 are copied to the volatile memory 21 of the risk servers at step S12.5. In some embodiments, the account manager server pushes the updated data to the risk manager servers to allow the risk manager servers to update the volatile memory 21 of the risk manager servers.

The risk manager starts carrying out the necessary steps to update the risk assessments for the risk groups, if necessary, as soon as it has been informed of changes that affect the risk groups. In some embodiments, the one or more risk servers that act as slaves to the account server responsible for processing the account update handle the risk assessments for the affected risk groups. The account manager may create a specific request for a risk assessment that is picked up by the allocated risk manager server. Alternatively, the risk manager server may determine whether an update to a risk assessment is needed based on the updated account information received from the account manager. Moreover, the risk manager server may determine that a risk assessment is required in accordance with a stored schedule.

When the risk calculations have been performed, the account manager is notified by the risk manager at step S12.6. The changes to the account and the risk assessment are then stored in the archive 12 at step S12.7. If the account changes did not prompt a risk assessment calculation, step S12.6 is skipped and only the updates to the account are stored in the archive at step S12.7.

It is then determined, at step S12.8, if any information needs to be sent to the trading system 2. The account manager needs to inform the trading system if a trade has been settled. Moreover, if the risk assessment shows that the risk associated with a member is too high, the clearing system may also tell the trading system not to accept any more orders from the member. However, the clearing house may first ask the member to provide additional collateral. In some situations, the clearing system may send a message to both the member and to the clearing house officials. The clearing house officials can then telephone the member if the member has not provided sufficient security after a predetermined time period. As a last resort, the trading system is informed and the member is prevented from trading until further collateral is provided. If it is determined at step S12.8 that information needs to be sent to the trading system 2, the account manager pushes the information, via the trading system interface 3, at step S12.9.

The account manager then determines what information should be published to the users of the system. The account manager determines the access group to which the account belongs and the details of the access group and the information that needs to be published are pushed to the publication manager at step S12.10. In some embodiment, the access group id may be included in the message as a tag.

By pushing the information to the risk manager and the publication manager instead of allowing the information to be requested or “pulled”, the user can be informed about risk updates and account changes much quicker after the event. In some embodiments, the account manager server may broadcast data to the risk manager servers and the publication manager servers. In some embodiments, the account manager server may push data to the risk manager servers and the publication manager servers using IP (Internet Protocol) multicast. The risk manager server and the publication manager server may reply using TCP/IP (Transmission Control Protocol/Internet Protocol).

Although it has been described with respect to FIG. 12 that the trade is processed and the account details are updated before details of the account update are copied to the risk servers, the account manager can copy the information necessary for the risk manager to start carrying out a risk assessments as soon as information about a change to an account is received. The risk assessment calculation and the processing of the account change can then be carried out in parallel.

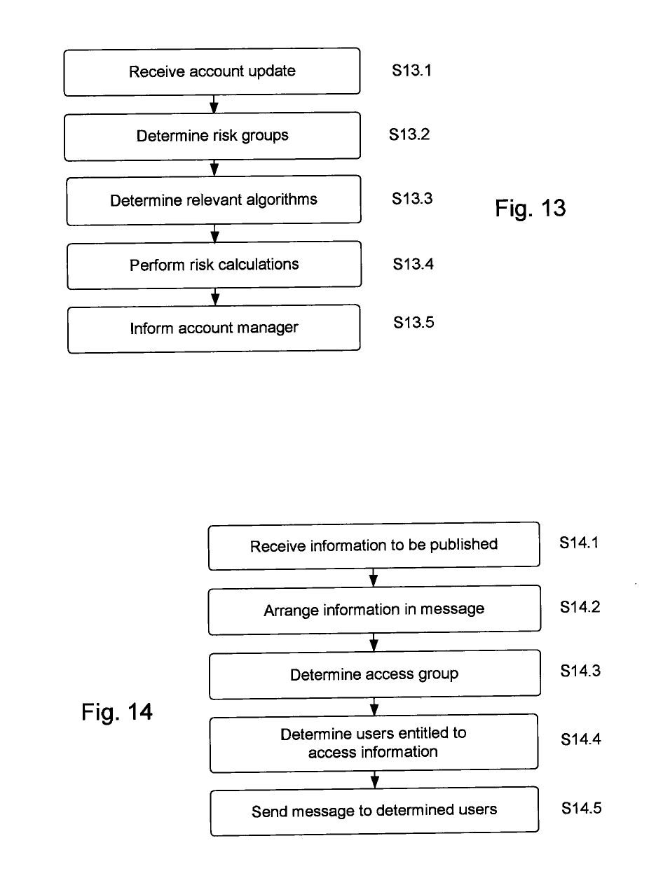

The process of calculating the risk will now be described in more detail with respect to FIG. 13. The risk manger controller 23 receives details of the account update at step S13.1. This may be as a result of information about the account update being copied to the volatile memory 21 of the risk manager. The information may be received from the account manager as a result of a new trade, new market data or a change to the structure into which the accounts are organised as described with respect to FIG. 12. Since the volatile memory 21 of the risk manager stores a copy of the account information in the volatile memory 15 of the account manager 4, the risk manager has access to all information needed to carry out the risk assessment. The risk manager controller 23 may also receive instructions to carry out a risk assessment. Alternatively, it may decide itself that a risk assessment is required. The allocated risk server determines the affected risk groups at step S13.2. As mentioned above, the allocated risk server may be a server that acts as a slave to the account server that processed the account update. After the risk groups have been determined, the risk controller 19 may instruct the risk calculator 20 to carry out the risk calculations for the determined risk groups.

The risk calculator 20 consults settings stored in memory 21 at step S13.3 to determine the risk calculation algorithms required for each group. It is contemplated that records in memory specify which default algorithms to be used for which instrument types. It is also contemplated that a record is stored for each risk group, specifying particular algorithms and parameters to use for that risk group. More than one risk algorithm may be used for each group. For example, different risk algorithms may be used for different instrument types.

The server then carries out the calculations at step S13.4. According to some embodiments, the risk assessment includes a margin requirement calculation. A margin requirement is used to cover the highest probable loss a portfolio may experience before the risk of the portfolio can be hedged in event of a default situation.

The smallest entity for which a risk calculation can be carried out is a risk netting group or information risk netting group as defined by the risk netting structure or information risk netting structure. Consequently, the calculations required for one group can be carried out by one server while the calculations required for another group can be carried out by another server. As mentioned above, an account can belong to more than one group. Different servers can carry out the risk assessments for the different groups to which the account belongs. The calculations may be carried out in parallel by the different servers. The calculations may also be carried out in parallel by different instances of the risk calculator in the same server. Alternatively, the calculations may be carried out in series by the same server. Some of the servers may have multiprocessor architecture to allow different calculations to be run at the same time. It is contemplated that, in some embodiments, different servers are used for risk assessments for different members. A server may determine the affected risk groups of an allocated member and update the risk assessments for the different risk groups in sequence. However, multithreading may be used for the individual calculations of a risk assessment. A server may also carry out a risk assessment based on the net position of a number of risk groups.

The risk manager controller 19 then notifies the account manager 4 that the risk calculations have been carried out at step S13.5. The risk manager may pass information about the updated risks for the groups, via the account manager interface 23, to the risk manager interface 17 of the account manager 4.

It is contemplated that different servers can be used for calculating risks required by the regulators and risks calculated for information purposes. Consequently, one set of servers may be used for calculating risks based on the risk netting groups, R1 to R4, and one set of servers may be used for calculating risks based on the information risk netting groups, IR1 to IR5. Alternatively, the same servers may be used for carrying out both risk assessments required by regulators and risk assessments for information purposes.

The process of publishing information to the users will now be described with respect to FIG. 14. The account manager interface 26 of the publication manager receives information to be published from the account manager 4 at step S14.1. The account manager may publish a broadcast message for the publication manager to pick up and distribute to the correct users. The publication manager can therefore acts as a gateway to the users. The information may comprise information about a settled trade and/or the result of a new risk calculation. The information also includes the access group which have access to the account to which the information relates. In one embodiment, the access group id is included in the header of the message as, for example, a tag.

The publication manager controller 24 arranges the information in a message at step S14.2 and notes the access groups that are allowed access to the information in the message at step S14.3. The publication manager then determines at step S14.4 whether a particular user is entitled to see the information. Users may submit requests to subscribe to information about certain accounts. The requests may be for a particular user or for all users of a particular member unit. When a request is received, a check may be carried out to see if the user or the member unit has the right to access a particular group. Referring to the user record of FIG. 10, this can be done by checking the access group id in the access group field 38. The accepted subscriptions are then organised according to the access group. As mentioned above, user access rights may be inherited vertically in the member and user tree structure. Consequently, users belonging to member units that are higher up in the hierarchy than a member unit that is associated with an access group may also be linked to the subscription. At step S14.4, the publication manager determines which users prescribe to information associated with a particular access group. The publication manager then sends the message to all the users that are entitled to be informed about changes to the accounts in the access group at step S14.5.

Whilst specific examples of the invention have been described, the scope of the invention is defined by the appended claims and not limited to the examples. The invention could therefore be implemented in other ways, as would be appreciated by those skilled in the art.

For example, it should be realised that the structure of the clearing system shown with respect to FIGS. 1, 2, 3 and 4 is only an example and a different structure can be used. For example, the trading system interface and the publication servers can be replaced by specific communication servers that handle external communication. Also, the contents of the accounts do not have to be stored in each individual server when the system is inactive. Instead, a common storage may be used. The common storage may be located in one of the account manager servers or externally of the account manager servers.

Although it has been described that the clearing system receives and handles trades from a trading system, the clearing system may also receive and handle trades from other institutions. The clearing system updates the accounts, carries out the risk assessments and may report to the party that informed the clearing system of the trade and to other parties affected by the trade.

1. A clearing system for clearing transactions associated with a plurality of accounts, the clearing system being configured to organize the plurality of accounts in at least three independent structures comprising a member structure, a user access structure, and a risk calculation structure.

2. The clearing system of claim 1, wherein the clearing system is configured to organize information corresponding to a plurality of members clearing through the clearing system and a plurality of users using the clearing system in a tree structure independent from said three independent structures.

3. The clearing system of claim 2, wherein the clearing system comprises a controller arrangement and a memory configured to organize information about the plurality of accounts, the plurality of members, and the plurality of users.

4. The clearing system of claim 3, wherein the controller arrangement is configured to receive information related to an account of the plurality of accounts and organize the received information with respect to the three independent structures in the memory.

5. The clearing system of claim 3, wherein the memory comprises an account database for organizing the information about the accounts in the three independent structures and a member database arrangement for organizing the information about the plurality of members and the plurality of users independently from said three independent structures.

6. The clearing system of claim 2, wherein the plurality of members comprise clearing members and non-clearing members, the member structure comprises a plurality of member groups, and the clearing system is configured to organize the accounts into member groups in dependence on the clearing member responsible for the account.

7. The clearing system of claim 6, wherein the user access structure comprises a plurality of user access groups and the clearing system is configured to organize the plurality of accounts into user access groups based on the one or more users allowed to access information about the accounts.

8. The clearing system of claim 7, wherein the risk calculation structure comprises a plurality of risk groups, and the clearing system comprises one or more risk calculation servers configured to calculate a risk for each risk group of the plurality of risk groups, the one or more risk calculation servers being configured to net the position of the accounts in each risk group of the plurality of risk groups.

9. The clearing system of claim 8, wherein the risk calculation structure comprises a first risk calculation structure comprising a first set of risk groups, and the clearing system is further configured to organize the accounts into a second risk calculation structure comprising a second set of risk groups, wherein the first set of risk groups is determined in accordance with risk assessments required by regulators and the second set of risk groups is determined based on information desired by users of the clearing system.

10. The clearing system of claim 9, wherein a risk group in the first set of risk groups and a risk group in the second set of risk groups comprise the same accounts, and wherein the one or more risk calculation servers are configured to carry out a stress-test for said accounts using the risk group of the second set of risk groups.

11. The clearing system of claim 8, further comprising a plurality of risk calculation servers configured to carry out risk calculations for the plurality of risk groups in parallel.

12. The clearing system of claim 8, further comprising
a database for storing for every account an indication of a member group to which the account belongs, an indication of a user access group to which the account belongs, and an indication of at least one risk calculation group to which the account belongs.

13. A method for managing accounts in a clearing system, the method comprising:
organizing accounts in at least three independent structures comprising a member account structure, a user access structure, and a risk calculation structure.

14. The method of claim 13, further comprising:
organizing a plurality of member units of members clearing through the clearing system in a tree structure independent from said three independent structures.

15. The method of claim 14, wherein the member account structure comprises a plurality of member groups, the user access structure comprises a plurality of user access groups, and the risk calculation structure comprises a plurality of risk groups.

16. The method of claim 15, further comprising:
organizing said accounts in a first and a second risk calculation structure, the first risk calculation structure comprising a first set of risk groups determined based on requirements of regulators, and the second risk calculation structure comprising a second set of risk groups determined based on information desired by users of the clearing system.

17. The method of claim 15, further comprising:
storing a record for each account in a database, the record comprising an indication of the member group to which the account belongs, an indication of a user access group to which the account belongs, and an indication of at least one risk group to which the account belongs; and
loading the content of said database into memory on start-up of the clearing system.

18. A non-transitory computer-readable storage device storing instructions that when executed by a processor, cause the processor to carry out the method of claim 13.

19. A data structure for organizing accounts in a clearing system, the data structure comprising:
a field comprising an indication of the member group to which an account belongs;
a field comprising an indication of a user access group to which the account belongs;
a field comprising an indication of a first risk group to which the account belongs; and
a field comprising an indication of at least a second risk group to which the account belongs.

20. A clearing system for clearing transactions associated with a plurality of accounts, the clearing system comprising:
means for organizing the plurality of accounts in at least three independent structures comprising a member structure, a user access structure and a risk calculation structure.

21. The clearing system of claim 20, comprising:
means for organizing information corresponding to a plurality of members clearing through the clearing system and a plurality of users using the clearing system in a tree structure independent from said three independent structures.
